(19) United States
(12) Patent Application Publication
(10) Pub. No.: US 2026/0064569 A1
(43) Pub. Date: Mar. 5, 2026

(54) GENERATIVE PRE-TRAINING TRANSFORMED (GPT) BASED CREATION OF AUTOMATED SCRIPT FOR APPLICATION TESTING

(71) Applicant: SAP SE, Walldorf (DE)

(72) Inventors: Ajith G., Ernakulam (IN); Ravikanth MALIPEDDU, Bangalore (IN); Shanavas Madeen S., Krishnagiri (IN); Naveen V., Hariharapura (IN)

(21) Appl. No.: 18/824,239

(22) Filed: Sep. 4, 2024

(51) Int. Cl. G06F 11/36

(52) U.S. Cl. CPC G06F 11/3684

(57) ABSTRACT

In some implementations, there is provided a computer-implemented method that includes determining, via the application function processor, a first suggested step for the test script, the first suggested step for the test script being a step of a workflow for the application obtained from the machine learning model; determining, via the orchestrating model, a first user interface control from a plurality of user interface controls stored within the object repository, and at least a first datum to be entered into a first input field, wherein the first user interface control is associated with a user interface location; and providing, by the orchestrating model and to the user interface, the first suggested step for the test script and a first locator associated with the first user interface control and entering at least the first datum into the first input field. Related systems, methods, and articles of manufacture are also disclosed.

### TECHNICAL FIELD

The present disclosure generally relates to software for guiding the flow of the creation of scripts, such as test scripts for automated application testing.

### BACKGROUND

Testing may be performed prior to the deployment and productive use of an update to a software application. The testing may take a variety of forms including functional tests that determine how the update to the application may affect existing components of the application.

### SUMMARY

In some implementations, there is provided a computer-implemented method including receiving, at an orchestrating model and from a user via a user interface, a request to create a test script for automated testing of an application of a plurality of applications, the request comprising an application tag identifying the application; sending, via the orchestrating model, the application tag to an application function processor, an object repository, and a test data container, wherein the application function processor is in communication with a machine learning model trained on at least one database containing one or more functions providing one or more workflows for at least the application; determining, via the application function processor, a first suggested step for the test script, the first suggested step for the test script being a step of a workflow for the application obtained from the machine learning model; determining, via the orchestrating model, a first user interface control from a plurality of user interface controls stored within the object repository, and at least a first datum to be entered into a first input field, wherein the first user interface control is associated with a user interface location; and providing, by the orchestrating model and to the user interface, the first suggested step for the test script and a first locator associated with the first user interface control and entering at least the first datum into the first input field.

In some variations, one or more features disclosed herein including one or more of the following features may be implemented as well. The method may further include upon receiving an indication that at least the first datum has been entered into the first input field, determining, by the application function processor, a second suggested step for the test script, a second user interface control and at least a second datum to be entered into a second input field; providing, by the orchestrating model and to the user interface, the second suggested step and a second locator corresponding to the second user interface control; and entering at least the second datum into the second input field. The first user interface control and the second user interface control may be provided by the object repository. The application function processor may determine the first suggested step for the test script and the second suggested step for the test script using the machine learning model comprising a large language model. At least a first document of a plurality of documents may list the one or more functions of the application. The first suggested step for the test script and the second suggested step for the test script may be steps including a guided flow described by a working model of at least the first document of the plurality of documents. At least the first datum to be entered into the first input field may be provided by a test data container. The test script may be provided to test the application, and record testing, using the script, of the application.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations.

In the drawings,

FIG. 1 illustrates a block diagram of an example of a system for creating scripts such as test scripts for automated application testing, in accordance with some embodiments;

FIG. 2A illustrates a diagram of a process flow for the creation of scripts, such as test scripts for automated application testing, in accordance with some embodiments;

FIG. 2B illustrates a set of elements associated with an application, in accordance with some embodiments; and

FIG. 3 illustrates another example of a system block diagram, in accordance with some embodiments.

### DETAILED DESCRIPTION

It may be necessary to test an application, including software updates to an application (“application update”) that may be in the form of a patch, a new release, and the like, prior to deployment of the update. Testing an application update prior to deployment may help determine if the update will negatively affect the function of an existing component of an application. Scripts for testing (“test scripts”) the application or application update may be manually created. The phrase “test script” refers to a series of steps performed to test an application or an application update. Manual creation of the test script may be time and resource intensive and highly dependent on the expertise of the creator of the script.

In some embodiments, there may be provided a machine learning model-based approach to create and configure a script, such as a test script. The use of the machine learning model may reduce the time and resources needed to create the script and may improve the quality of the script as the creation is not limited to the expertise of a single script creator (but rather includes the learning from a larger set of knowledge databases). Although some of the examples refer to the creation of a test script, other types of scripts may be created as well.

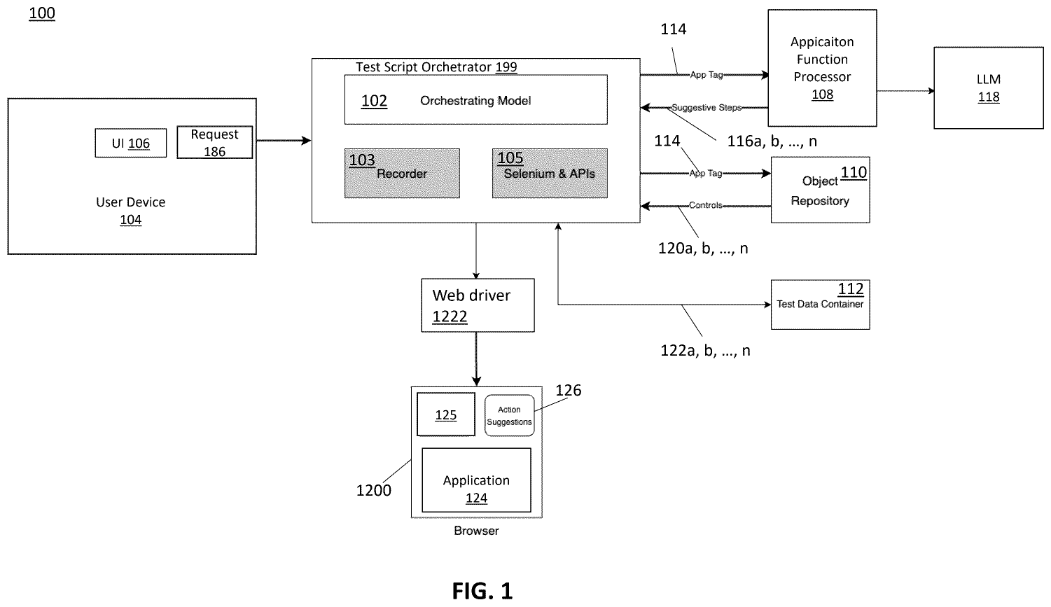

FIG. 1 depicts a diagram illustrating an example of a system 100 consistent with implementations of the current subject matter. The system 100 is configured to create a test script for automating the testing of an application.

In the example of FIG. 1, the system 100 may include a test script orchestrator 199 and an orchestrating model 102 configured to orchestrate the association between certain application functions and certain controls using a machine leaning model, such as a large language model (LLM) 118.

In the example of FIG. 1, the orchestrating model 102 receives one or more inputs. The one or more inputs may include an application identifier (e.g., an application tag (“app tag”)) identifying an application, such as application 124. The one or more inputs may also include an indication to initiate recording by a recorder 103 configured to record the testing of the application (e.g., using a browser recorder to record testing at the application 124). The one or more inputs may be in the form of (or included in) a request 186 to create an automated test script for the application 124 that is the subject of the test script being created. For example, a user interface 106 at a user device 104 may be used to select or trigger the request 186 sent by the user device to the orchestrating model 102. The orchestrating model 102 may also be in communication with an application function processor 108, an object repository 110, and a test data container 112. The orchestrating model 102 may also be in communication, via a web driver 1222, with the browser 1200.

In the example of FIG. 1, the orchestrating model 102 includes the recorder 103 configured to record each action performed on the user interface 106 of the user device 104. In some implementations, the recorder 103 may perform the recording using, for example, a JavaScript event handler. For example, if a function of the application 124 is tested, such as selection of a user interface element or entry of a value in a data field, as part of the test script the recorder 103 in conjunction with the browser recorder 125 records those operations or actions on the user interface, such as the browser 1200. The orchestrating model 102 includes other components 105, such as APIs to browser automation tools and/or the like.

In operation, a user may access the user interface 106 of the user device 104 to initiate creation of a script, such as a test script, for testing the application 124. To that end, the user device 104 may send the request 186 to create an automated test script of a certain application. As noted, the user device 104 may send the request to the orchestrating model 102. In some implementations, the request may include an identifier for the application 124 (which is the subject of the testing by the automated test script). The identifier may comprise an application tag 114 identifying the application 124 to be tested, although the identifier may take other forms as well, such as a uniform resource locator (URL) or other type of identifier of the identity or location of the application 124. The recorder 103 may use the application tag 114 to navigate to the application 124 as part of the recording of the testing using the test script.

In response to receiving the request 186, the orchestrating model 102 may trigger a first API at the application function processor 108 by sending the application tag 114 to the application function processor 108, which responds with one or more functional steps 116a-n for the application 124 identified by the application tag. And, the orchestrating model 102 may trigger a second API at the object repository 110 by sending the application tag 114 to the application function processor 108.

In response to receiving the application tag 114, the application function processor 108 may be configured to search for a document associated with the application 124 associated with the application tag 114. The document then provides a list of one or more functional steps needed to be performed by the application 124. For example, the application function processor 108 may return the one or more functional steps 116a-n as a response to the orchestrating model 102.

To illustrate by way of an example, the request 186 may identify the application 124 as a Create Sales Order application (which in this example is the subject of the test script). As such, the corresponding application tag 114 may be #SalesOrder-create. The Create Sale Order application may, in this example, have steps, such as “Enter Sales Document Type”, “Enter Company Code”, Click on Continue button”, “Enter Ship-to-Party”, “Enter Sold-to-Party”, “Enter Material”, and “Enter Quantity” in a functional flow of the application. Some if not all of these steps of functions may be ordered in a time-based sequence (e.g., step 1 followed by steps 2 and so forth). The application function processor 108 may return these steps as “suggested steps” 116a-n upon receipt of the request 186 (and the application tag 114) to test the application 124 as these are the steps (also referred to as “functions”) needed to create the test script.

In some embodiments, the application function processor 108 may use a machine learning model, such as a large language model (LLM) 118, to provide the list of one or more functional steps needed to be performed by the application 124. For example, the application function processor 108 may send a request (or prompt) for a list of the one or more functional steps associated with the application 124, and the LLM 118 may respond with the list of one or more functional steps needed to be performed by the application 124.

In some implementations, each application (which may be the subject of test creation using system 100) may have a unique application tag that identifies the functional steps associated with testing a corresponding application. When this is the case, the application function processor 108 uses an application tag to identify a corresponding document that contains the one or more functional steps for the corresponding application.

As noted, the object repository 110 may also receive the application tag 114. The object repository includes a collection of controls, such as interactive controls (e.g., user interface elements, such as buttons, checkboxes, toggles, text fields (e.g., where values/data can be entered), drop downs, radio buttons, navigational elements, etc.) for a plurality of applications. Moreover, the object repository may include properties for the controls, such as a label, an identifier, an XPATH (used to for example navigate to a portion of an XML document associated with the control), and/or the like. The object repository may return to the orchestrating model 102 one or more controls 120a, b, and n associated with the application 124 under test.

In some embodiments, the orchestrating model 102 receives the one or more functional steps 116a-n and the one or more controls 120a-n and then associates the one or more functional steps 116a-n with the one or more controls 120a-n. In operation for example, for each functional step (which is provided by the application function processor 108) the orchestrating model 102 identifies a corresponding control for the functional step and associates the functional step with the control. Referring again to the Create Sales Order application example, the application function processor 108 may return a suggested step for the application 124 (which is identified by the application tag 114). In this example, the suggested step may be, for example, “Enter Sales Document Type”.

The object repository 110 may include, as noted, a collection of controls associated with (e.g., linked to, mapped to, identified by, etc.) a corresponding application tag. For example, given the application tag 114, the object repository may identify one or more controls for application 124 and properties for the controls. Moreover, the object repository 110 may also store unique identifiers of the controls corresponding to the application tag 114. The identifiers may include, for example, ID, label, and xpath. These properties can be used for uniquely identifying the object repository control in the application 124. The orchestrating model 102 associates the suggested step 116a-n and the control from the object repository 110. For example, the orchestrating model 102 may associate a suggested step with an identifier such as “label”. Upon the orchestrating model 102 associating a suggested step 116a-n with an identifier, such as label, stored in the object repository 110, the object repository may provide a response in the form of a JSON as shown in Table 1. As seen at Table 1, the label property may be used for associating the suggested step “Enter Sales Document Type” to the control.

TABLE 1
{
“label”: “Sales Document Type”,
“xpath”: “//input[contains(@lsdata,′wnd[0]/usr/ctxtVBAK-AUART′)]”,
“id”: “M0:46:::2:22”,
“classname”: “lsField_{——}input”,
“sid”: “wnd[0]/usr/ctxtVBAK-AUART”
}

Based on the response received from the object repository 110 at 120, the orchestrating model 102 may provide the one or more suggested steps 116a-n to the user interface 106 for display and may then highlight on the user interface the corresponding control element where the action for that functional step should be performed. To illustrate further, the object repository 110 may include one or more unique properties (e.g., label, xpath, ID) associated with the possible application tag 114. The object repository 110 may use any number of properties to uniquely identify an element or control corresponding to the properties in the application's user interface 106 (UI). The application's user interface 106 may be described by an HTML document, and all of the elements of the HTML document may have unique properties (e.g., label, ID, xpath) that can be used to identify the control from the application document or application's user interface 106. In this example, as a functional step and a control element is selected at the user interface, the application function processor 108 tracks the selection and then based on the selection proposes another (e.g., subsequent or next) functional step and corresponding control element. Moreover, the application function processor 108 may compare the selection (which is performed at the user interface 106) with the suggested functional step from the application function processor. Based on the comparison, the application function processor 108 may make an informed decision on the next suggested step 116a-n. For each suggested step 116a-n, the orchestrating model 102 may highlight a corresponding control element on the user interface 106 and suggest input data to the end user. In some implementations, a user of user device 104 can select a step that is not suggested by system 100. Furthermore, a user accessing the user device 104 may at any point stop the creation of the automated test script by system 100 and switch to a manual creation of the test script. The suggestions and selections may thus form a series of ordered functions (or steps) and corresponding controls for the application, such as the application 124, that will be tested using an automated test script and recorded via the recorder 103 and browser recorder 125.

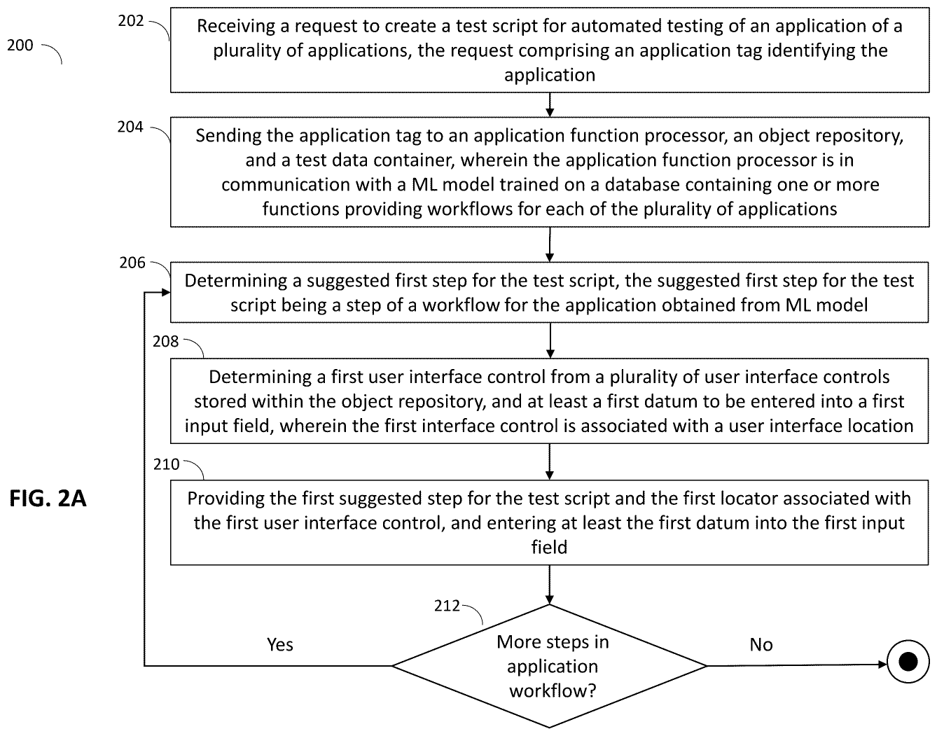

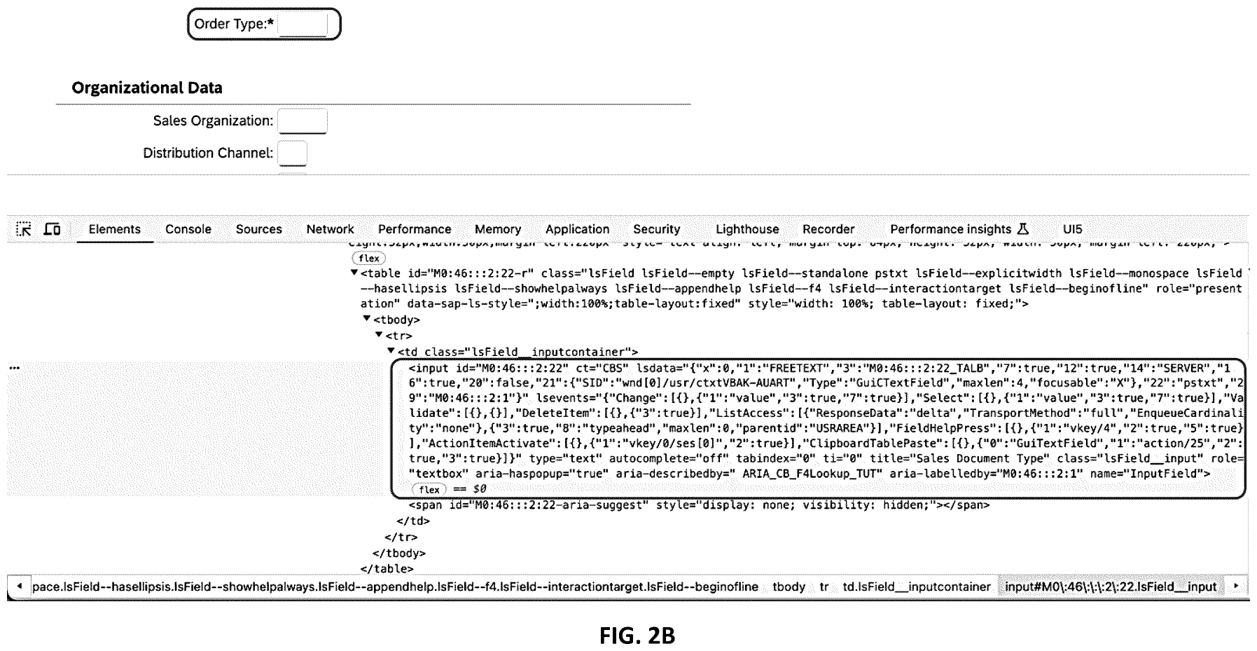

As shown in FIG. 2B, elements of the HTML document that describe an application (e.g., an application “Create Sales Document”) may include, e.g., “title” and “class”. These elements may be stored in object repository 110 and may be associated with a suggested step of a test script by application function processor 108 and orchestrating model 102, as described above.

Referring again to the application function processor 108, it may determine at least a first suggested step 116a for the creation of the automated test script using a large language model (LLM) 118. The LLM 118 may be trained on a knowledge base containing a plurality of documents. Each of the plurality of documents on which LLM 118 is trained may contain information (e.g., a working model or workflow) for the particular application corresponding to the application tag 114. The working model or workflow described in each application on which LLM 118 is trained may contain a flow of process steps that need to be performed in a specific application. From this flow, application function processor 108 may determine the first suggested step 116a in the creation of an automated test script.

The application function processor 108 uses the application tag 114 to determine the document in a knowledge database (e.g., a database containing documents on which LLM 118 is trained) related to the application to be tested and to determine the steps described by the document that need to be performed to achieve functionality within the application. The application function processor 108 then returns the necessary suggested steps 116a, 116b, . . . , 116n in the sequence. There may be an arbitrary number of suggested steps 116 provided by the application function processor 108 in accordance with some embodiments. By ensuring that LLM 118 is trained on these documents that describe known flows of existing applications, predictability, efficiency, and efficacy of automated test script creation are improved, and disruption to existing functional components of applications is minimized on deployment of application updates.

In some implementations, orchestrating model 102 is configured to execute the first suggested step 116a provided by the application function processor 108 to user interface 106. In certain implementations, a user of user device 104 decides to execute the first suggested step 116a provided by the application function processor 108. Upon receiving an indication that the first suggested step 116a has been executed, either by orchestrating model 102 or by a user of user device 104, the application function processor 108 may be configured to provide to user interface 106 (via the orchestrating model 102) at least a second suggested step 116b. In general, any number of suggested steps 116a, 116b, . . . , 116n may be provided to a user of user device 104 by the application function processor 108 based on the workflow described by the document corresponding to the application tag 114 that is included in the request to generate an automated test script for the application.

In some implementations, after the application function processor 108 provides a first suggested step 116a, the orchestrating model 102 provides a first user interface control 120a to user interface 106. The first user interface control 120a may be a control or action that can be taken by a user of user device 104 in order to satisfy a suggested step 116a, 116b, . . . , 116n. The first user interface control 120a may have a corresponding locator on user interface 106. The first user interface control 120a and its corresponding locator are determined by orchestrating model 102 using object repository 110. Object repository 110 comprises a collection of all interactable controls for a particular application. Object repository 110 further stores all properties associated with a given control, including e.g., a label, the ID, the xpath, and the application tag 114.

Upon receipt of the application tag 114 in the request sent from user device 104, orchestrating model 102 scans the tables of the object repository 110 and extracts all controls associated with the application tag 114. The locator corresponding to first user interface control 120a may help guide the user of system 100 to the exact location on user interface 106 of the action to be performed according to the first suggested step 116a.

Further, orchestrating model 102 may provide at least a first datum 122a to be entered into a first input field of user interface 106. Object repository 110 may hold information about the controls (e.g., their labels, technical name, and other details captured from earlier adaption of those applications). The controls may be mapped with the test data container 112 fields corresponding to them so that the data will be used to populate the corresponding fields on user interface 106 of user device 104 during creation of the test script. Orchestrating model 102 may receive at least the first datum 122a from test data container 112. In some implementations, orchestrating model 102 is configured to enter at least the first datum 122a into the first input field of user interface 106. In certain implementations, a user of user device 104 decides to enter at least the first datum 122a into the first input field of user interface 106. The user device 104 can intervene at any point during the creation of the test script so that orchestrating model 102 may not create the test script for automated application testing entirely without input from the user device 104. Although some of the arrows in FIG. 1 have an arrow point in a given direction, the requests, data, etc., may flow in either direction.

Once the controls are extracted from the object repository 110, the orchestrating model 102, together with the recorder 103, has a unique algorithm of associating inputs from the application function processor 108 and the object repository 110. In some implementations, first suggested step 116a, first user interface control 120, and at least the first datum 122 are provided to the user device 104 via user interface 106 sequentially. Other suggested steps 116b, . . . , 116n may be provided by the application function processor 108 as described above.

For each suggested step 116 provided by the application function processor 108, orchestrating model 102 and the recorder determine a corresponding control from object repository 110. The orchestrating model 102 then highlights the control on user interface 106 where an action corresponding to the step 116 and control is to be performed. The orchestrating model 102 highlights the control on the user interface 106 based on the unique properties of the elements stored in the object repository 110, including the label, xpath, and ID. The application function processor 108 keeps track of the actions performed by a user of user device 104 responsive to the receipt of a suggested step 116 and compares the actions taken by the user of the user device 104 with the suggested steps 116. The application function processor 108 uses this comparison to decide the next suggested step 116.

Upon receiving an indication that at least the first datum 122 has been entered into the first input field of user interface 106, orchestrating model 102 may be configured to provide, from the application function processor 108, a second suggested step 116b for the creation of an automated test script test for the application that the user of user device 104 seeks to test. After providing the second suggested step 116, orchestrating model 102 may be configured to provide a second user interface control 120b to the user device 104 via user interface 106. The second user interface control 120b may have a corresponding locator. As described above with respect to the first user interface control and corresponding locator associated with the first suggested step 116a, the second user interface control 120b and its corresponding locator are determined by orchestrating model 102 from object repository 110. Further, the application function processor 108 may provide at least a second datum 122b to be entered into a second input field of user interface 106. The application function processor 108 may receive at least the second datum 122b from test data container 112. In some implementations, orchestrating model 102 is configured to enter at least the second datum 122b into the second input field of user interface 106. In certain implementations, the user device 104 may enter at least the second datum 122b into the second input field of user interface 106.

FIG. 2A illustrates one example of a process 200 for creating a test script for automated application testing, in accordance with some embodiments. The description of FIG. 2A also refers to FIG. 1. For example, the process 200 may comprise a computer-implemented method performed, for example, by the system 100 (or one or more of the components of FIG. 1). Moreover, some of the aspects the process 200 may be performed at least in part by the orchestrating model 102.

At 202, a request including an application tag to create a test script for automated testing of an application of a plurality of applications is received. As described above with respect to FIG. 1, the request may be received by an orchestrating model, such as orchestrating model 102. The request may be input by a user of a system for creating a test script for automated testing of an application, such as user of user device 104 of system 100. The request may be input via a user interface, such as user interface 106.

At 204, the application tag is sent to the application function processor, an object repository, and a test data container. For example, the application tag 114 may be sent to the application function processor 108, the object repository 110, and the test data container 112. Moreover, the application function processor may communicate with a machine learning model, such as the LLM 118, to obtain suggested steps. In some embodiments, the LLM 118 may be trained using one or more databases (e.g., one or more knowledge bases of documents describing applications to be tested). Thes databases may store one or more workflows, such as functional steps or suggested steps for testing one or more applications.

At 206, there is determined a first suggested step for the test script, the first suggested step for the test script being a step of a workflow for the application obtained from the machine learning model. For example, the LLM 118 may, as noted, be trained on the knowledge base of one or more documents describing applications to be tested, such that the application function processor 108 can determine a suggested step for creating the test script for automated testing of the application in accordance with known application flows as described in the documents.

At 208, a first user interface control from a plurality of user interface controls stored within the object repository and at least a first datum to be entered into a first input field are determined. The first interface control may be associated with a user interface location. The user interface control and at least a first datum may be determined by the orchestrating model 102 using at least the object repository 110. This first datum may be determined from a test data container.

At 210, the first suggested step for the test script and the locator corresponding associated with the first user interface control are provided to the user device. As described above, an orchestrating model 102 may provide to the user device 104 the suggested step and the locator (which locates the user interface control). The suggested step and the locator may be presented via the user interface 106. Referring again to 208, the at least the first datum may be entered into a first input field, such as a first input field of user interface 106. As described above with respect to FIG. 1, the at least a datum may be entered into a corresponding input field either manually by a user device 104, or automatically by the orchestrating model 102.

At 212, it is assessed whether or not there are additional suggested steps for the test script to be recommended to a user of the system implanting the method. If there are additional suggested steps (“Yes” at 212), the process 200 may repeat from 206, where additional suggested steps may be determined. If there are not additional suggested steps (“No” at 212), then the process 200 ends. In general, system 100 of FIG. 1 may be configured to execute process 200 iteratively until all suggested steps for the test script creation of a particular application are provided to a user of system 100.

Once all the suggested steps 116a-n for the application are provided to the user of user device 104, the application is launched in the browser 1200. As described above, the orchestrating model 102 works with object repository 110 to identify appropriate controls corresponding to suggested steps for the user of browser 1200. The test script orchestrator 199 then provides the test script to a user of the browser so that testing and recording of the application can proceed. As the user of the browser tries to perform actions on the application in the browser 1200, the recorder 103 of test script orchestrator 199 records the actions using the generated test script.

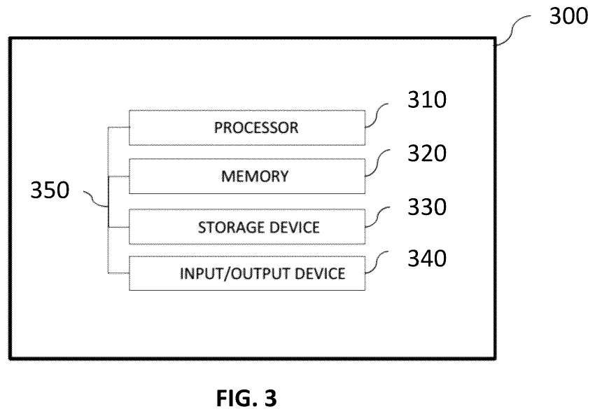

In some implementations, the current subject matter may be configured to be implemented in a system 300, as shown in FIG. 3. The system 300 may include a processor 310, a memory 320, a storage device 330, and an input/output device 340. The processor 310 of FIG. 3 may be used to implement one or more of the functions of FIG. 1, such as the application function processor 108, and/or the like. Each of the components (e.g., processor 310, memory 320, storage device 330 and input/output device 340) may be interconnected using a system bus 380. The processor 310 may be configured to process instructions for execution within the system 300. In some implementations, the processor 310 may be a single-threaded processor. In alternate implementations, the processor 310 may be a multi-threaded processor. The processor 310 may be further configured to process instructions stored in the memory 320 or on the storage device 330, including receiving or sending information through the input/output device 340. The memory 320 may store information within the system 300. In some implementations, the memory 320 may be a computer-readable medium. In alternate implementations, the memory 320 may be a volatile memory unit. In yet some implementations, the memory 320 may be a non-volatile memory unit. The storage device 330 may be capable of providing mass storage for the system 300. In some implementations, the storage device 330 may be a computer-readable medium. In alternate implementations, the storage device 330 may be a floppy disk device, a hard disk device, an optical disk device, a tape device, non-volatile solid-state memory, or any other type of storage device. The input/output device 340 may be configured to provide input/output operations for the system 300. In some implementations, the input/output device 340 may include a keyboard and/or pointing device. In alternate implementations, the input/output device 340 may include a display unit for displaying graphical user interfaces.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document, ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium can store such program instructions non-transitorily, such as for example as would a non-transient solid-state memory or a magnetic hard drive or any equivalent storage medium. The machine-readable medium can alternatively or additionally store such machine instructions in a transient manner, such as would a processor cache or other random-access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1. A computer-implemented method comprising:
receiving, at an orchestrating model and from a user via a user interface, a request to create a test script for automated testing of an application of a plurality of applications, the request comprising an application tag identifying the application;
sending, via the orchestrating model, the application tag to an application function processor, an object repository, and a test data container, wherein the application function processor is in communication with a machine learning model trained on at least one database containing one or more functions providing one or more workflows for at least the application;
determining, via the application function processor, a first suggested step for the test script, the first suggested step for the test script being a step of a workflow for the application obtained from the machine learning model;
determining, via the orchestrating model, a first user interface control from a plurality of user interface controls stored within the object repository, and at least a first datum to be entered into a first input field, wherein the first user interface control is associated with a user interface location; and
providing, by the orchestrating model and to the user interface, the first suggested step for the test script and a first locator associated with the first user interface control and entering at least the first datum into the first input field.

Example 2. The computer-implemented method of Example 1, further comprising, upon receiving an indication that at least the first datum has been entered into the first input field,
determining, by the application function processor, a second suggested step for the test script, a second user interface control and at least a second datum to be entered into a second input field;
providing, by the orchestrating model and to the user interface, the second suggested step and a second locator corresponding to the second user interface control; and
entering at least the second datum into the second input field.

Example 3. The computer-implemented method of any of Examples 1-2, wherein the first user interface control and the second user interface control are provided by the object repository.

Example 4. The computer-implemented method of any of Examples 1-3, wherein the application function processor determines the first suggested step for the test script and the second suggested step for the test script using the machine learning model comprising a large language model.

Example 5. The computer-implemented method of any of Examples 1-4, wherein at least a first document of a plurality of documents lists the one or more functions of the application.

Example 6. computer-implemented method of any of Examples 1-5, wherein the first suggested step for the test script and the second suggested step for the test script are steps comprising a guided flow described by a working model of at least the first document of the plurality of documents.

Example 7. The computer-implemented method of any of Examples 1-6, wherein the at least the first datum to be entered into the first input field is provided by a test data container.

Example 8. The computer-implemented method of any of Examples 1-7, wherein the test script is provided to test the application, and record testing, using the script, of the application.

Example 9. A system comprising:
at least one processor; and
at least one memory including instructions which when executed by the at least one processor causes operations comprising:
   receiving, at an orchestrating model and from a user via a user interface, a request to create a test script for automated testing of an application of a plurality of applications, the request comprising an application tag identifying the application;
   sending, via the orchestrating model, the application tag to an application function processor, an object repository, and a test data container, wherein the application function processor is in communication with a machine learning model trained on at least one database containing one or more functions providing one or more workflows for at least the application;
   determining, via the application function processor, a first suggested step for the test script, the first suggested step for the test script being a step of a workflow for the application obtained from the machine learning model;
   determining, via the orchestrating model, a first user interface control from a plurality of user interface controls stored within the object repository, and at least a first datum to be entered into a first input field, wherein the first user interface control is associated with a user interface location; and
   providing, by the orchestrating model and to the user interface, the first suggested step for the test script and a first locator associated with the first user interface control and entering at least the first datum into the first input field.

Example 10. The system of Example 9, further comprising, upon receiving an indication that at least the first datum has been entered into the first input field,
determining, by the application function processor, a second suggested step for the test script, a second user interface control and at least a second datum to be entered into a second input field;
providing, by the orchestrating model and to the user interface, the second suggested step and a second locator corresponding to the second user interface control; and
entering at least the second datum into the second input field.

Example 11. The system any of Examples 9-10, wherein the first user interface control and the second user interface control are provided by the object repository.

Example 12. The system any of Examples 9-11, wherein the application function processor determines the first suggested step for the test script and the second suggested step for the test script using the machine learning model comprising a large language model.

Example 13. The any of Examples 9-11, wherein at least a first document of a plurality of documents lists the one or more functions of the application.

Example 14. The system of claim 13, wherein the first suggested step for the test script and the second suggested step for the test script are steps comprising a guided flow described by a working model of at least the first document of the plurality of documents.

Example 15. The any of Examples 9-14, wherein the at least the first datum to be entered into the first input field is provided by a test data container.

Example 16. The any of Examples 9-15, wherein the test script is provided to test the application, and record testing, using the script, of the application.

Example 17. A non-transitory computer-storage medium including instructions which when executed by at least one processor causes operations comprising:
receiving, at an orchestrating model and from a user via a user interface, a request to create a test script for automated testing of an application of a plurality of applications, the request comprising an application tag identifying the application;
sending, via the orchestrating model, the application tag to an application function processor, an object repository, and a test data container, wherein the application function processor is in communication with a machine learning model trained on at least one database containing one or more functions providing one or more workflows for at least the application;
determining, via the application function processor, a first suggested step for the test script, the first suggested step for the test script being a step of a workflow for the application obtained from the machine learning model;
determining, via the orchestrating model, a first user interface control from a plurality of user interface controls stored within the object repository, and at least a first datum to be entered into a first input field, wherein the first user interface control is associated with a user interface location; and
providing, by the orchestrating model and to the user interface, the first suggested step for the test script and a first locator associated with the first user interface control and entering at least the first datum into the first input field.

Example 18. The non-transitory computer-storage medium of Example 17, further comprising, upon receiving an indication that at least the first datum has been entered into the first input field,
determining, by the application function processor, a second suggested step for the test script, a second user interface control and at least a second datum to be entered into a second input field;
providing, by the orchestrating model and to the user interface, the second suggested step and a second locator corresponding to the second user interface control; and
entering at least the second datum into the second input field.

Example 19. The non-transitory computer-storage medium of any of Examples 17-18, wherein the first user interface control and the second user interface control are provided by the object repository.

Example 20. The non-transitory computer-storage medium of any of claims 17-19, wherein the application function processor determines the first suggested step for the test script and the second suggested step for the test script using the machine learning model comprising a large language model.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method comprising:
receiving, at an orchestrating model and from a user via a user interface, a request to create a test script for automated testing of an application of a plurality of applications, the request comprising an application tag identifying the application;
sending, via the orchestrating model, the application tag to an application function processor, an object repository, and a test data container, wherein the application function processor is in communication with a machine learning model trained on at least one database containing one or more functions providing one or more workflows for at least the application;
determining, via the application function processor, a first suggested step for the test script, the first suggested step for the test script being a step of a workflow for the application obtained from the machine learning model;
determining, via the orchestrating model, a first user interface control from a plurality of user interface controls stored within the object repository, and at least a first datum to be entered into a first input field, wherein the first user interface control is associated with a user interface location; and
providing, by the orchestrating model and to the user interface, the first suggested step for the test script and a first locator associated with the first user interface control and entering at least the first datum into the first input field.

2. The computer-implemented method of claim 1, further comprising, upon receiving an indication that at least the first datum has been entered into the first input field,
determining, by the application function processor, a second suggested step for the test script, a second user interface control and at least a second datum to be entered into a second input field;
providing, by the orchestrating model and to the user interface, the second suggested step and a second locator corresponding to the second user interface control; and
entering at least the second datum into the second input field.

3. The computer-implemented method of claim 2, wherein the first user interface control and the second user interface control are provided by the object repository.

4. The computer-implemented method of claim 2, wherein the application function processor determines the first suggested step for the test script and the second suggested step for the test script using the machine learning model comprising a large language model.

5. The computer-implemented method of claim 4 wherein at least a first document of a plurality of documents lists the one or more functions of the application.

6. The computer-implemented method of claim 5, wherein the first suggested step for the test script and the second suggested step for the test script are steps comprising a guided flow described by a working model of at least the first document of the plurality of documents.

7. The computer-implemented method of claim 1, wherein the first datum to be entered into the first input field is provided by a test data container.

8. The computer-implemented method of claim 1, wherein the test script is provided to test the application, and record testing, using the test script, of the application.

9. A system comprising:
at least one processor; and
at least one memory including instructions which when executed by the at least one processor causes operations comprising:
receiving, at an orchestrating model and from a user via a user interface, a request to create a test script for automated testing of an application of a plurality of applications, the request comprising an application tag identifying the application;
sending, via the orchestrating model, the application tag to an application function processor, an object repository, and a test data container, wherein the application function processor is in communication with a machine learning model trained on at least one database containing one or more functions providing one or more workflows for at least the application;
determining, via the application function processor, a first suggested step for the test script, the first suggested step for the test script being a step of a workflow for the application obtained from the machine learning model;
determining, via the orchestrating model, a first user interface control from a plurality of user interface controls stored within the object repository, and at least a first datum to be entered into a first input field, wherein the first user interface control is associated with a user interface location; and
providing, by the orchestrating model and to the user interface, the first suggested step for the test script and a first locator associated with the first user interface control and entering at least the first datum into the first input field.

10. The system of claim 9, further comprising, upon receiving an indication that at least the first datum has been entered into the first input field,
determining, by the application function processor, a second suggested step for the test script, a second user interface control and at least a second datum to be entered into a second input field;
providing, by the orchestrating model and to the user interface, the second suggested step and a second locator corresponding to the second user interface control; and
entering at least the second datum into the second input field.

11. The system of claim 10, wherein the first user interface control and the second user interface control are provided by the object repository.

12. The system of claim 10, wherein the application function processor determines the first suggested step for the test script and the second suggested step for the test script using the machine learning model comprising a large language model.

13. The system of claim 12, wherein at least a first document of a plurality of documents lists the one or more functions of the application.

14. The system of claim 13, wherein the first suggested step for the test script and the second suggested step for the test script are steps comprising a guided flow described by a working model of at least the first document of the plurality of documents.

15. The system of claim 9, wherein the first datum to be entered into the first input field is provided by a test data container.

16. The system of claim 9, wherein the test script is provided to test the application, and record testing, using the test script, of the application.

17. A non-transitory computer-storage medium including instructions which when executed by at least one processor causes operations comprising:
receiving, at an orchestrating model and from a user via a user interface, a request to create a test script for automated testing of an application of a plurality of applications, the request comprising an application tag identifying the application;
sending, via the orchestrating model, the application tag to an application function processor, an object repository, and a test data container, wherein the application function processor is in communication with a machine learning model trained on at least one database containing one or more functions providing one or more workflows for at least the application;
determining, via the application function processor, a first suggested step for the test script, the first suggested step for the test script being a step of a workflow for the application obtained from the machine learning model;
determining, via the orchestrating model, a first user interface control from a plurality of user interface controls stored within the object repository, and at least a first datum to be entered into a first input field, wherein the first user interface control is associated with a user interface location; and
providing, by the orchestrating model and to the user interface, the first suggested step for the test script and a first locator associated with the first user interface control and entering at least the first datum into the first input field.

18. The non-transitory computer-storage medium of claim 17, further comprising, upon receiving an indication that at least the first datum has been entered into the first input field,
determining, by the application function processor, a second suggested step for the test script, a second user interface control and at least a second datum to be entered into a second input field;
providing, by the orchestrating model and to the user interface, the second suggested step and a second locator corresponding to the second user interface control; and
entering at least the second datum into the second input field.

19. The non-transitory computer-storage medium of claim 18, wherein the first user interface control and the second user interface control are provided by the object repository.

20. The non-transitory computer-storage medium of claim 18, wherein the application function processor determines the first suggested step for the test script and the second suggested step for the test script using the machine learning model comprising a large language model.
